(19) United States
(12) Patent Application Publication
(10) Pub. No.: US 2013/0120853 A1
(43) Pub. Date: May 16, 2013

(54) ZOOM LENS AND IMAGE PICKUP APPARATUS INCLUDING THE SAME

(71) Applicant: Canon Kabushiki Kaisha, Tokyo (JP)

(72) Inventors: Yasuaki Hagiwara, Utsunomiya-shi (JP); Yoshihisa Tashiro, Nikko-shi (JP)

(73) Assignee: CANON KABUSHIKI KAISHA, Tokyo (JP)

(21) Appl. No.: 13/676,889

(22) Filed: Nov. 14, 2012

(30) Foreign Application Priority Data
Nov. 16, 2011 (JP) 2011-250499

(51) Int. Cl. G02B 15/14

(52) U.S. Cl. CPC G02B 15/14
USPC 359/684

(57) ABSTRACT

Provided is a zoom lens comprising, in order from an object side to an image side, a first lens unit having positive refracting power; a second lens unit having negative refracting power; a third lens unit having positive refracting power; a fourth lens unit having negative refracting power; and a fifth lens unit having positive refracting power, wherein the lens units move when zooming from the wide-angle end to the telephoto end; the third lens unit and the fifth lens unit move together when zooming; the fifth lens unit includes an aperture stop in the optical path thereof; the third lens unit or the fourth lens unit moves during focusing; and the following conditional expression is satisfied: 0.5<|f2|/skw<3.0 where f2 is the focal length of the second lens unit, and skw is a back focus at the wide-angle end.

### BACKGROUND OF THE INVENTION

1. Field of the Invention

The present invention relates to a zoom lens and an image pickup apparatus equipped with the zoom lens. The zoom lens may find industrial application in an image pickup apparatus using a solid-state image pickup device, such as a video camera, an electronic still camera, a broadcasting camera, and a surveillance camera, or an image pickup apparatus such as a camera using a silver halide film, among others.

2. Description of the Related Art

A compact zoom lens having a high-zoom-ratio and a high resolution is required as an imaging optical system for use in an image pickup apparatus. Particularly, a zoom lens that achieves size reduction of the entire image pickup apparatus by adopting an advanced lens layout and an innovative zooming method considering mechanism elements, such as a zooming mechanism and an autofocusing mechanism, is required.

It is known that both size reduction of the entire system and high zoom ratio of the zoom lens can generally be achieved by increasing the refracting power and the amount of movement of the zoom lens unit when zooming. However, although increasing the refracting power and the amount of movement of the zoom lens unit makes it easy to achieve a high zoom ratio, it also increases a change in aberration when zooming. Generally, the change in aberration tends to deteriorate image quality. Thus, it becomes difficult to obtain high optical performance over the entire zooming range.

A zoom lens that includes five lens units having positive, negative, positive, negative, and positive refracting power in order from the object side to the image side and performs zooming by moving three or more lens units is known, for example, from U.S. Pat. No. 8,107,171 and Japanese Patent Application Laid-Open No. 2008-3511.

To simultaneously achieve all of the high zoom ratio, size reduction of the entire lens system, and high optical performance in such conventional zoom lenses, it is important to appropriately set the refracting power, moving conditions for zooming, and other like parameters for all lens units in a balanced and accurate manner. It is particularly important to appropriately set the refracting power and the amount of movement for zooming of a second lens unit in the zoom lens. Unless the configurations of these parameters are appropriately set, it is significantly difficult to simultaneously achieve all of the high zoom ratio, size reduction of the entire lens system, and high optical performance of the entire zooming range.

### SUMMARY OF THE INVENTION

Embodiments of present invention disclose a compact, high-zoom-ratio zoom lens capable of providing high optical performance over the entire zooming range, and an image pickup apparatus including the zoom lens.

According to at least one embodiment of the present invention, a zoom lens comprises, in order from an object side to an image side, a first lens unit having positive refracting power; a second lens unit having negative refracting power; a third lens unit having positive refracting power; a fourth lens unit having negative refracting power; and a fifth lens unit having positive refracting power, wherein the lens units move when zooming from the wide-angle end to the telephoto end; the third lens unit and the fifth lens unit move together when zooming; the fifth lens unit includes an aperture stop; the third lens unit or the fourth lens unit moves during focusing; and the following conditional expression is satisfied:

0.5<|f2|/skw<3.0

where f2 is the focal length of the second lens unit, and skw is a back focus at the wide-angle end.

Further features of the present invention will become apparent from the following description of exemplary embodiments with reference to the attached drawings.

### BRIEF DESCRIPTION OF THE DRAWINGS

FIG. 1 is a cross-sectional view of a zoom lens of Example 1 at a wide-angle end.

FIG. 2A is an aberration diagram of the zoom lens of Example 1 at the wide-angle end.

FIG. 2B is an aberration diagram of the zoom lens of Example 1 at an intermediate zooming position.

FIG. 2C is an aberration diagram of the zoom lens of Example 1 at a telephoto end.

FIG. 3 is a cross-sectional view of a zoom lens of Example 2 at the wide-angle end.

FIG. 4A is an aberration diagram of the zoom lens of Example 2 at the wide-angle end.

FIG. 4B is an aberration diagram of the zoom lens of Example 2 at the intermediate zooming position.

FIG. 4C is an aberration diagram of the zoom lens of Example 2 at the telephoto end.

FIG. 5 is a cross-sectional view of a zoom lens of Example 3 at the wide-angle end.

FIG. 6A is an aberration diagram of the zoom lens of Example 3 at the wide-angle end.

FIG. 6B is an aberration diagram of the zoom lens of Example 3 at the intermediate zooming position.

FIG. 6C is an aberration diagram of the zoom lens of Example 3 at the telephoto end.

FIG. 7 is a cross-sectional view of a zoom lens of Example 4 at the wide-angle end.

FIG. 8A is an aberration diagram of the zoom lens of Example 4 at the wide-angle end.

FIG. 8B is an aberration diagram of the zoom lens of Example 4 at the intermediate zooming position.

FIG. 8C is an aberration diagram of the zoom lens of Example 4 at the telephoto end.

FIG. 9 is a cross-sectional view of a zoom lens of Example 5 at the wide-angle end.

FIG. 10A is an aberration diagram of the zoom lens of Example 5 at the wide-angle end.

FIG. 10B is an aberration diagram of the zoom lens of Example 5 at the intermediate zooming position.

FIG. 10C is an aberration diagram of the zoom lens of Example 5 at the telephoto end.

FIG. 11 is a schematic diagram of the relevant part of an image pickup apparatus according to an embodiment of the present invention.

### DESCRIPTION OF THE EMBODIMENTS

Embodiments of the present invention will be described in detail hereinbelow with reference to the accompanying drawings. The zoom lens according to an embodiment of the present invention includes, in order form the object side to the image side, a first lens unit having positive refracting power, a second lens unit having negative refracting power, a third lens unit having positive refracting power, a fourth lens unit having negative refracting power, and a fifth lens unit having positive refracting power. When zooming from a wide-angle end to a telephoto end, the lens units move. When zooming, the third lens unit and the fifth lens unit move together. An aperture stop is disposed in the fifth lens unit. When focusing, the third lens unit or the fourth lens unit moves.

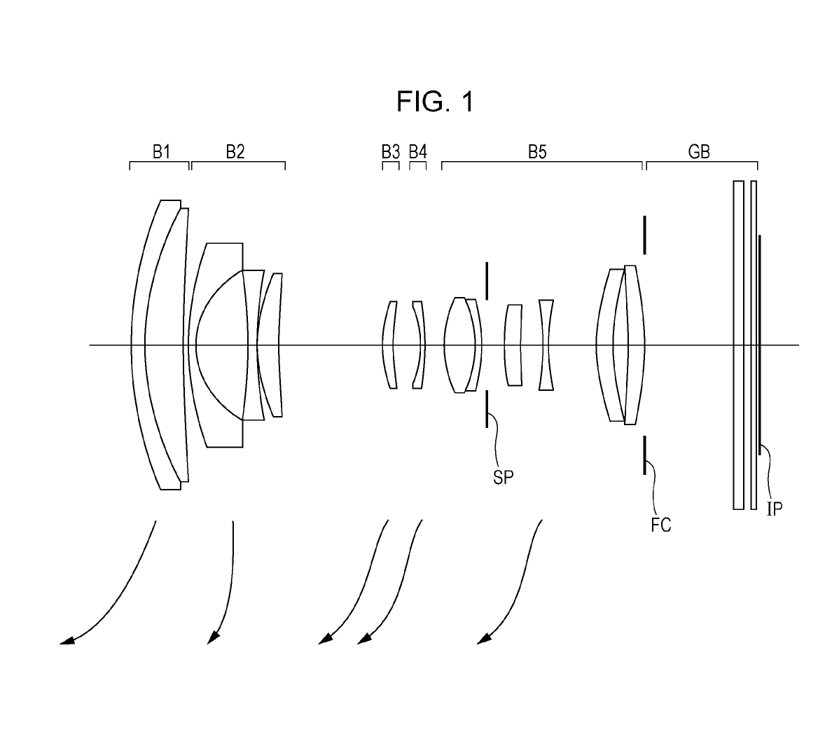

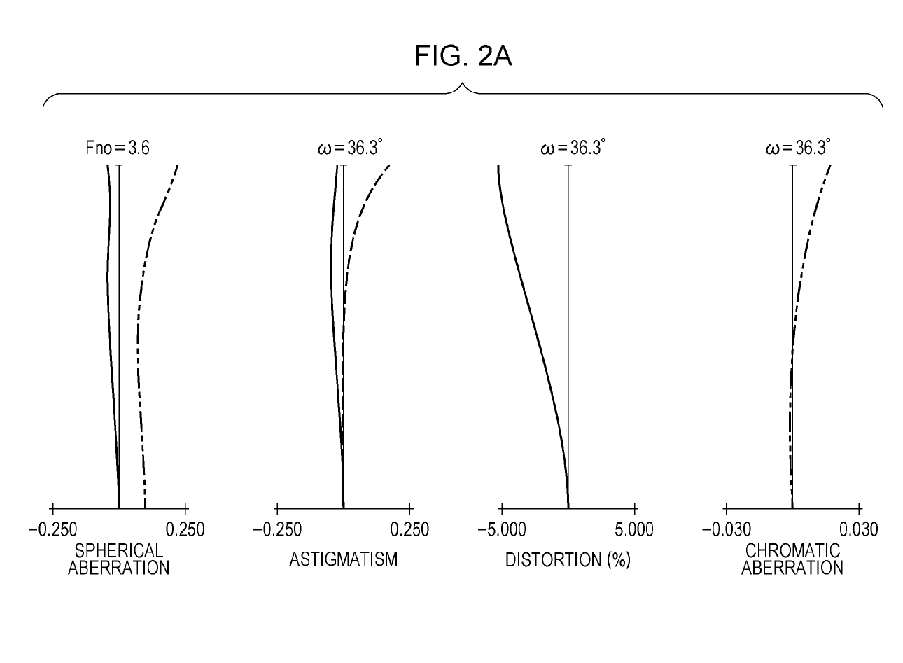

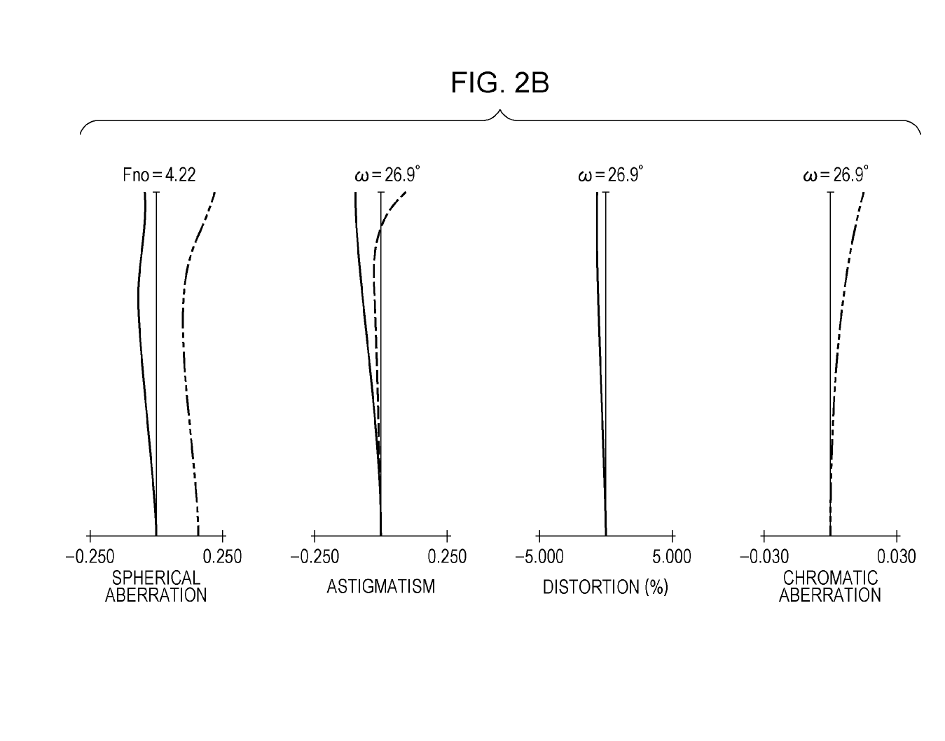

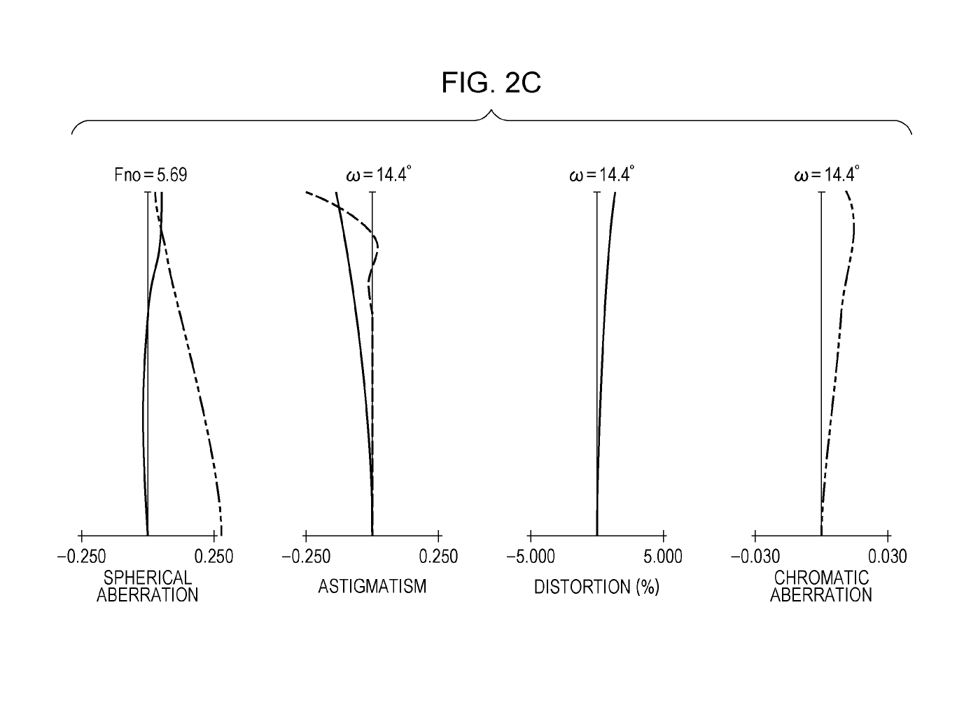

FIG. 1 is a cross-sectional view of a zoom lens of Example 1 of the present invention, at the wide-angle end (short focal length end). FIGS. 2A, 2B, and 2C are aberration diagrams of the zoom lens of Example 1 at the wide-angle end, an intermediate zooming position, and the telephoto end (long focal length end), respectively. Example 1 is a zoom lens having a zoom ratio of 2.87 and an aperture ratio of about 3.60 to 5.69.

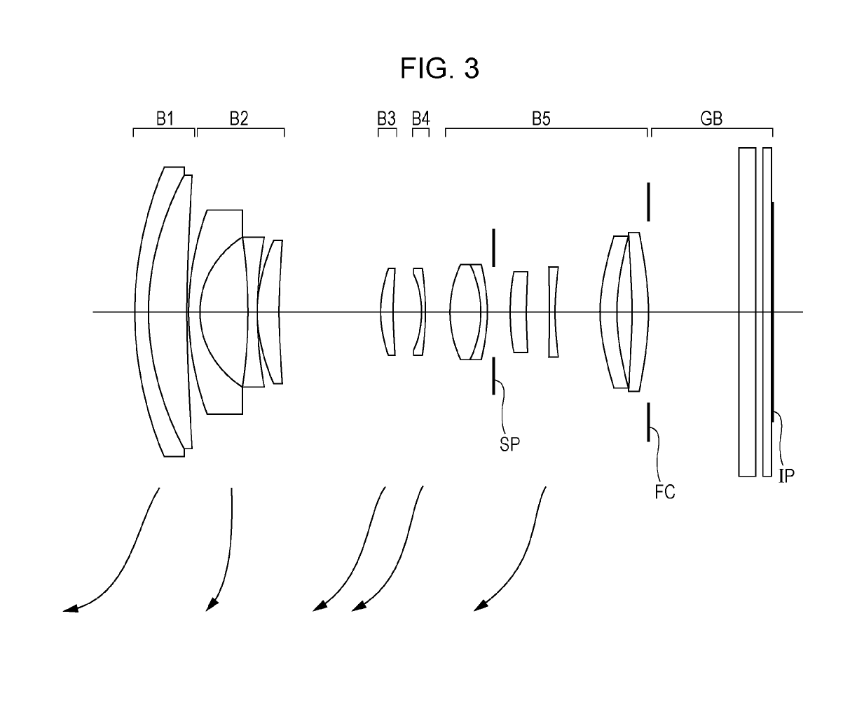

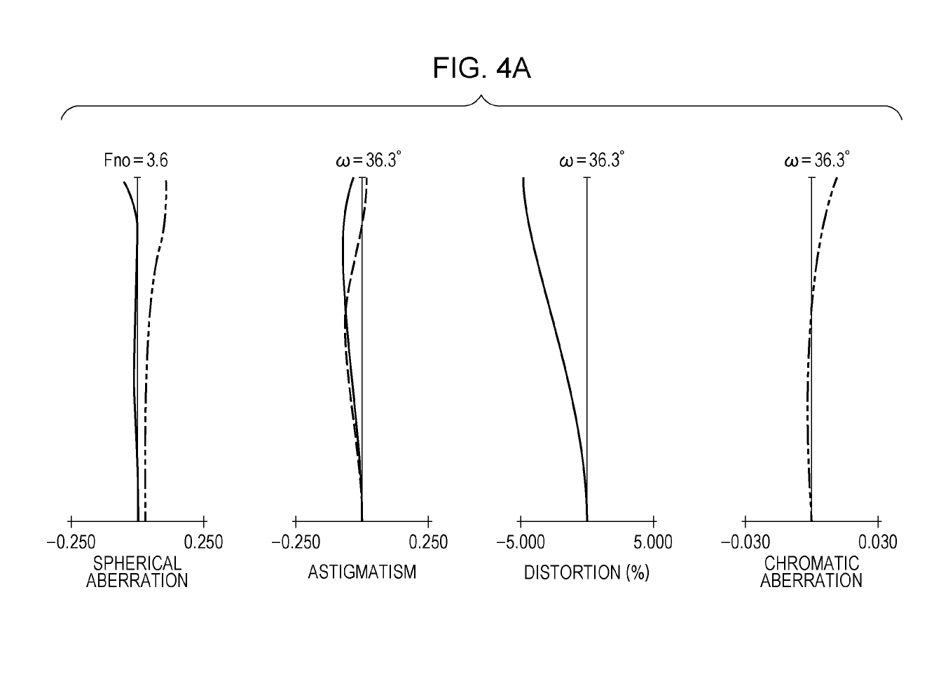

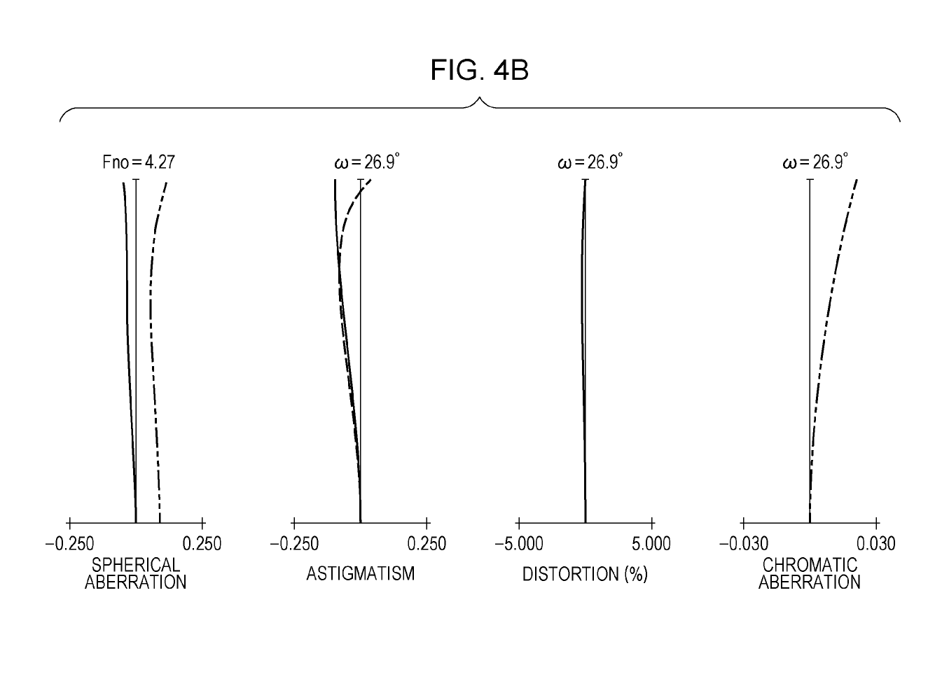

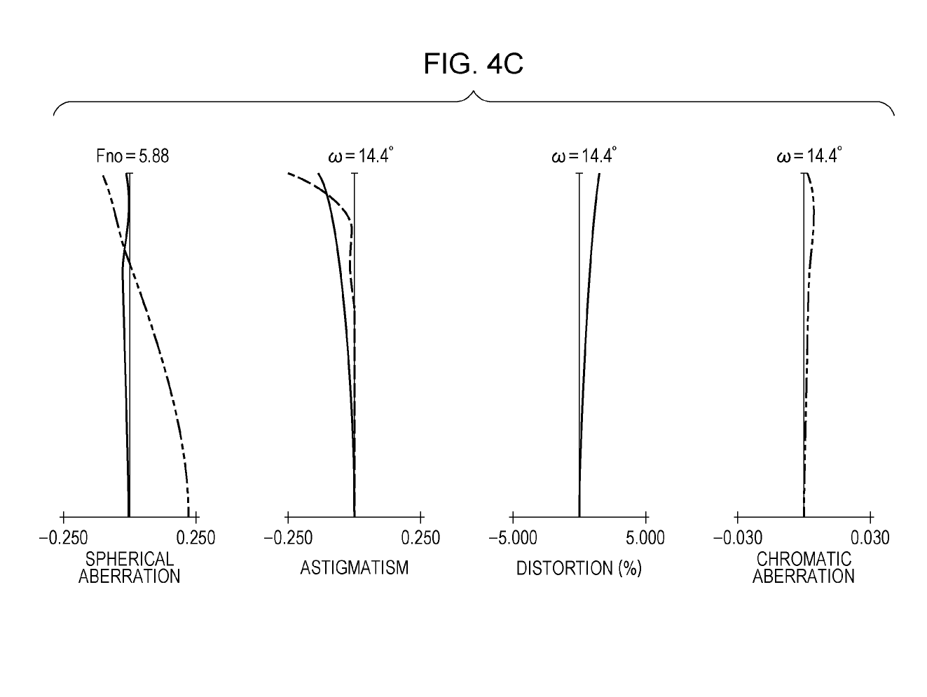

FIG. 3 is a cross-sectional view of a zoom lens of Example 2 of the present invention, at the wide-angle end. FIGS. 4A, 4B, and 4C are aberration diagrams of the zoom lens of Example 2 at the wide-angle end, the intermediate zooming position, and the telephoto end, respectively. Example 2 is a zoom lens having a zoom ratio of 2.87 and an aperture ratio of about 3.60 to 5.88.

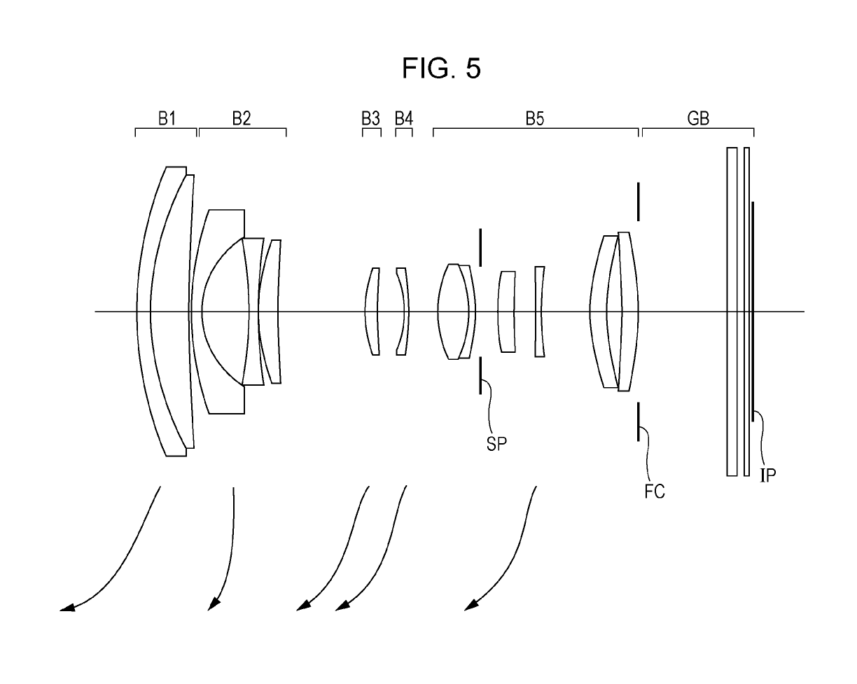

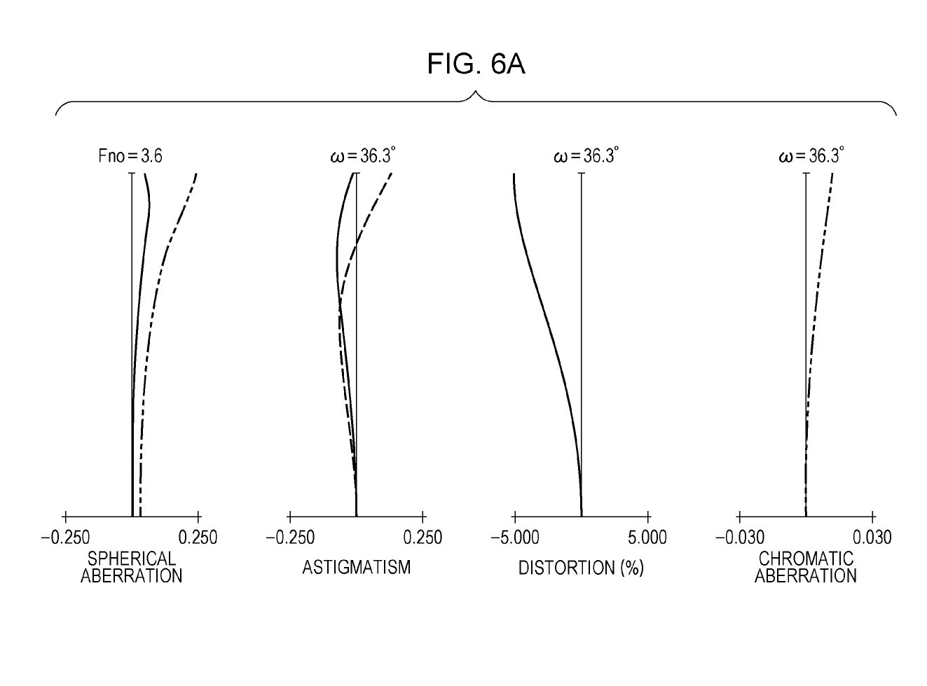

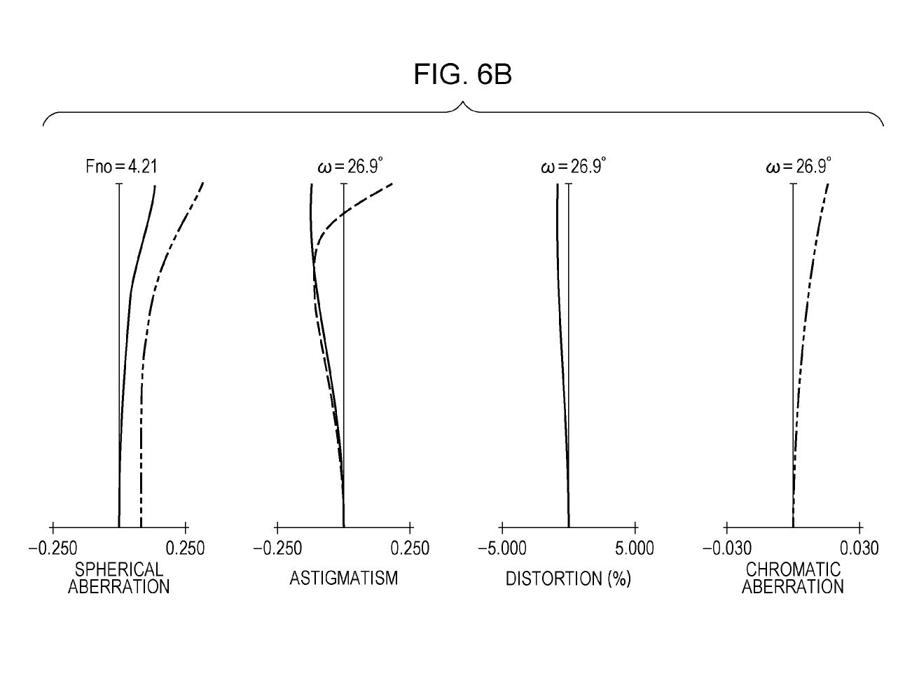

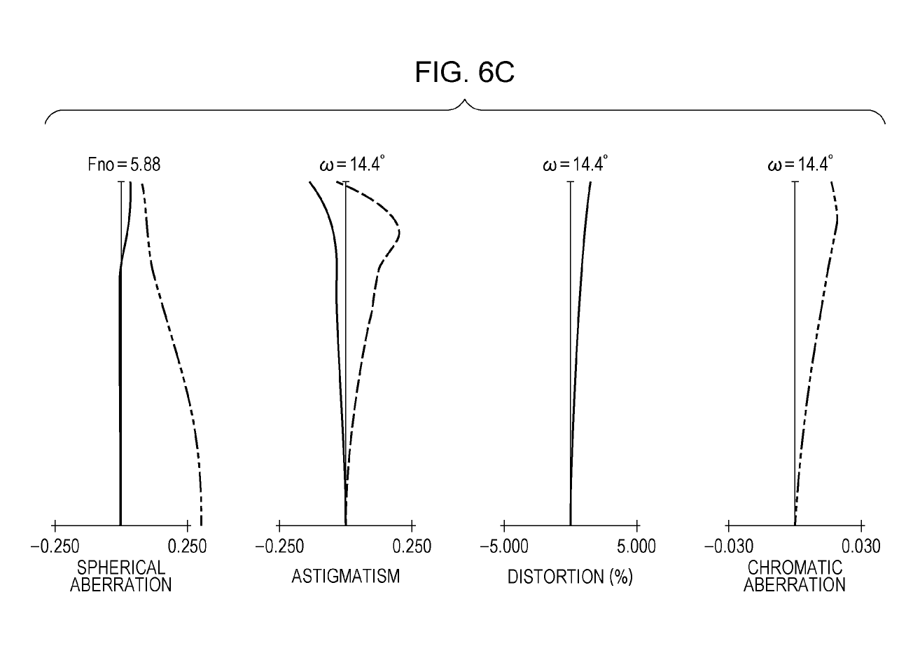

FIG. 5 is a cross-sectional view of a zoom lens of Example 3 of the present invention, at the wide-angle end. FIGS. 6A, 6B, and 6C are aberration diagrams of the zoom lens of Example 3 at the wide-angle end, the intermediate zooming position, and the telephoto end, respectively. Example 3 is a zoom lens having a zoom ratio of 2.87 and an aperture ratio of about 3.60 to 5.88.

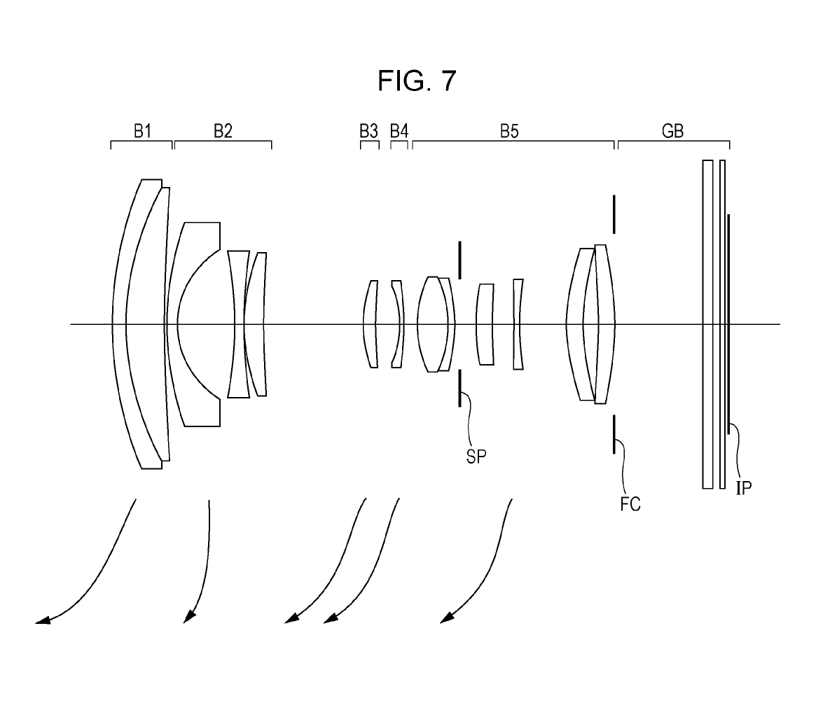

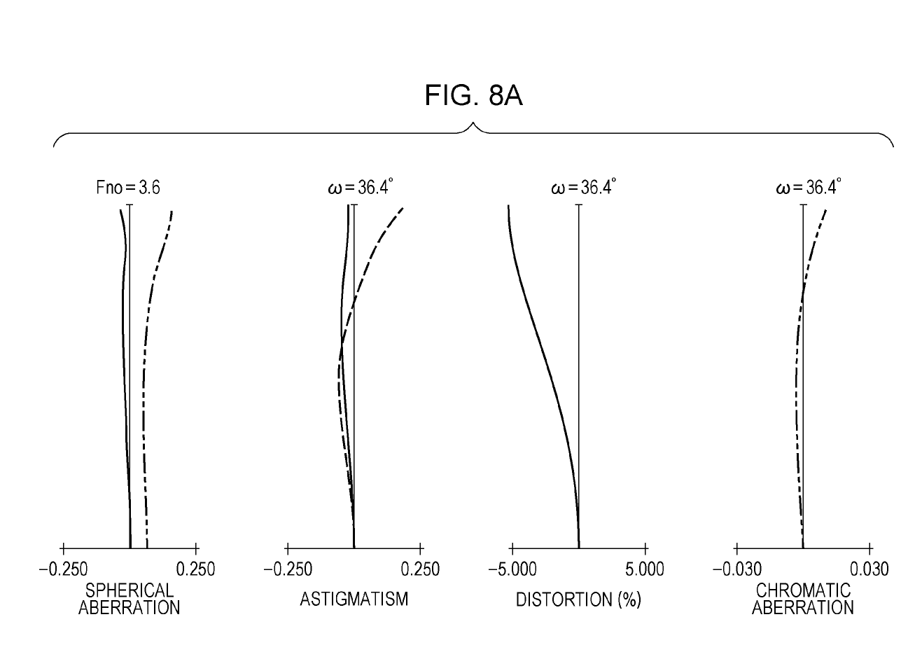

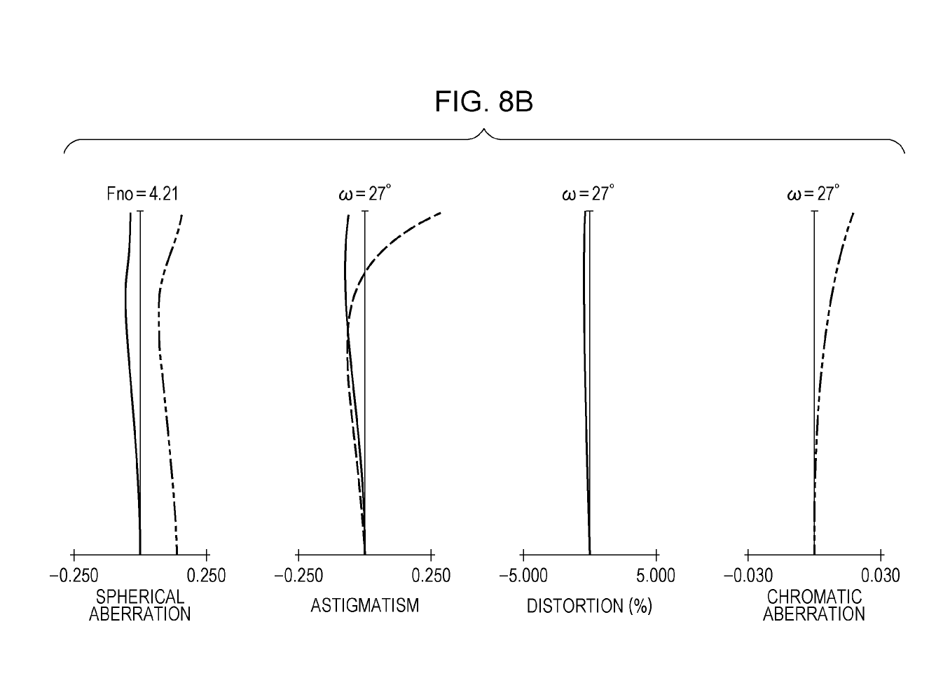

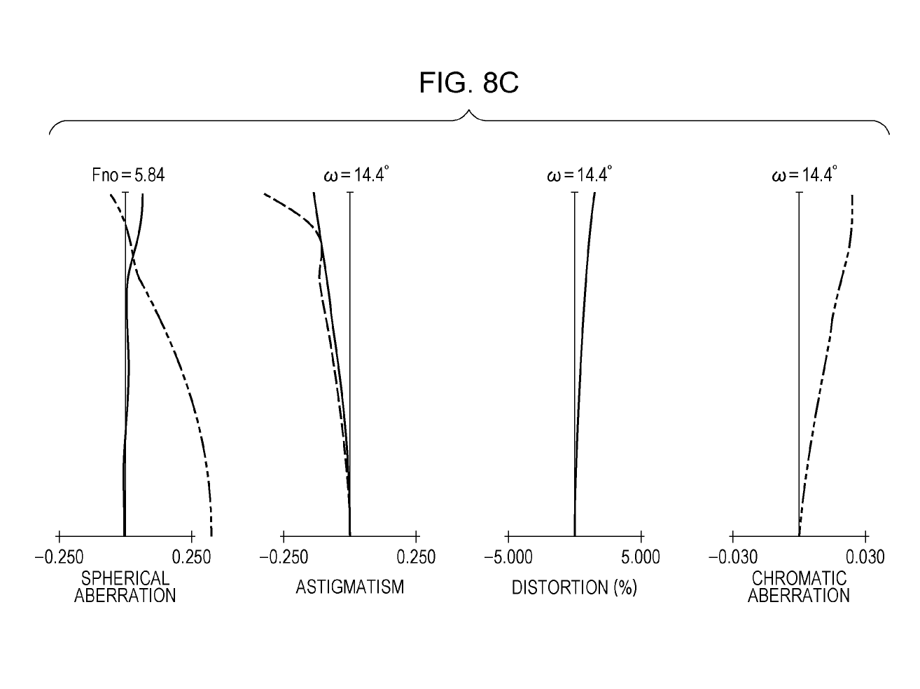

FIG. 7 is a cross-sectional view of a zoom lens of Example 4 of the present invention, at the wide-angle end. FIGS. 8A, 8B, and 8C are aberration diagrams of the zoom lens of Example 4 at the wide-angle end, the intermediate zooming position, and the telephoto end, respectively. Example 4 is a zoom lens having a zoom ratio of 2.88 and an aperture ratio of about 3.60 to 5.84.

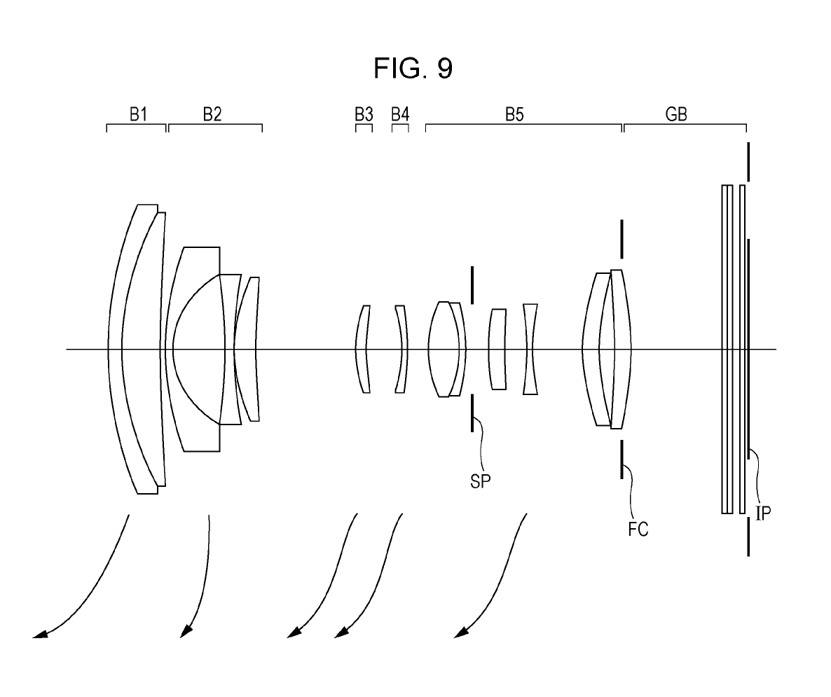

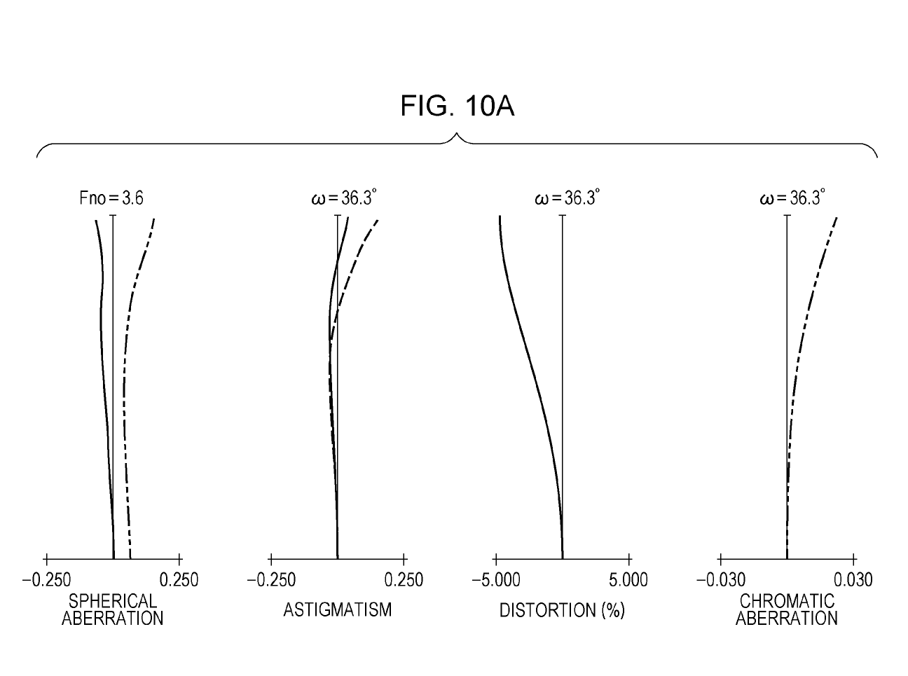

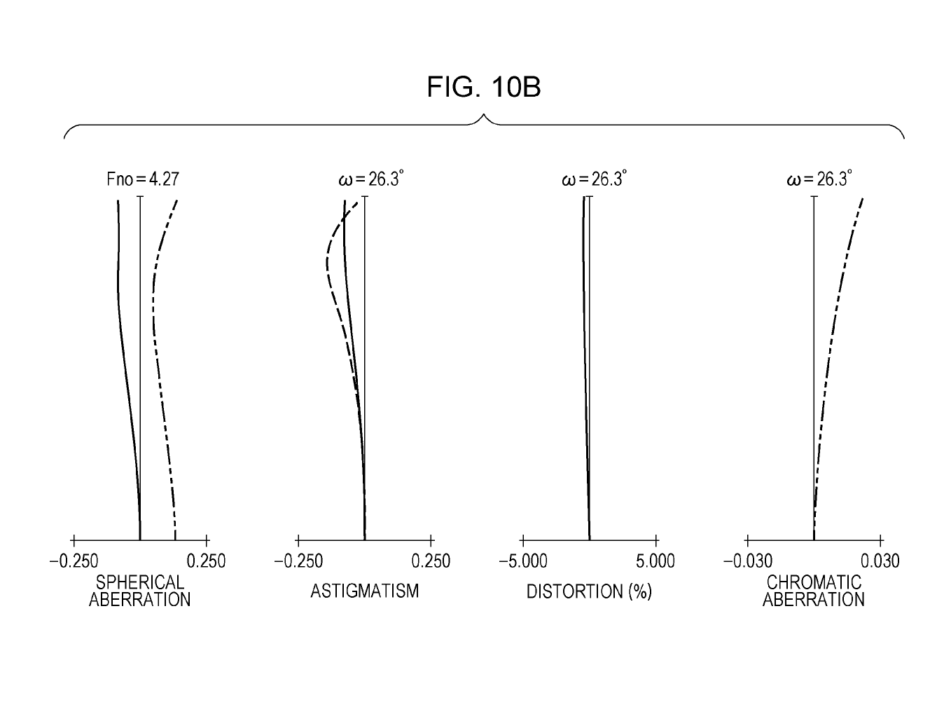

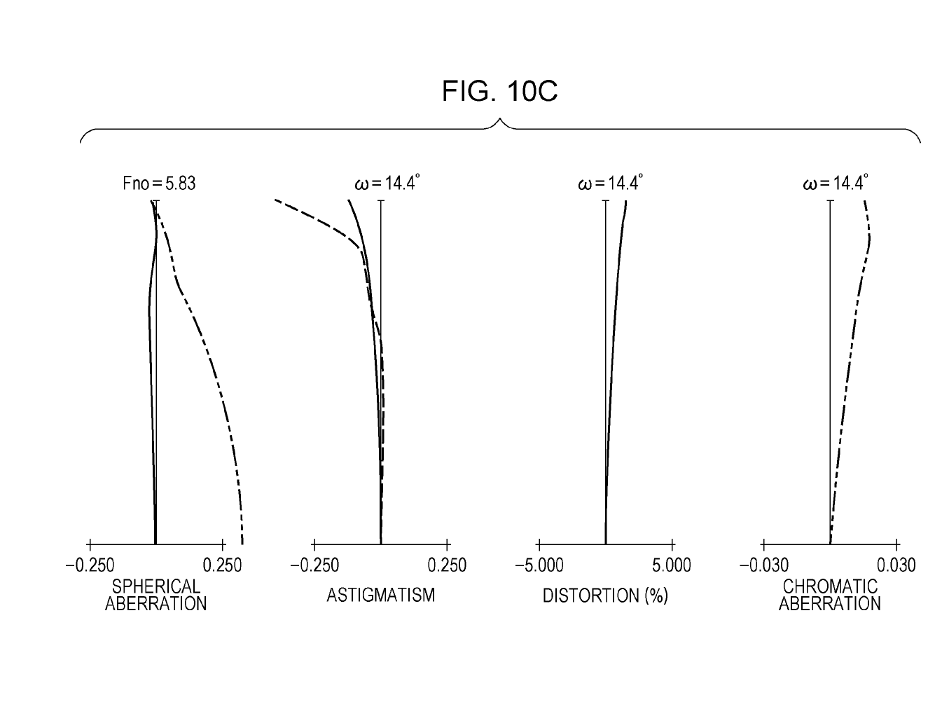

FIG. 9 is a cross-sectional view of a zoom lens of Example 5 of the present invention, at the wide-angle end. FIGS. 10A, 10B, and 10C are aberration diagrams of the zoom lens of Example 5 at the wide-angle end, the intermediate zooming position, and the telephoto end, respectively. Example 5 is a zoom lens having a zoom ratio of 2.87 and an aperture ratio of about 3.60 to 5.83.

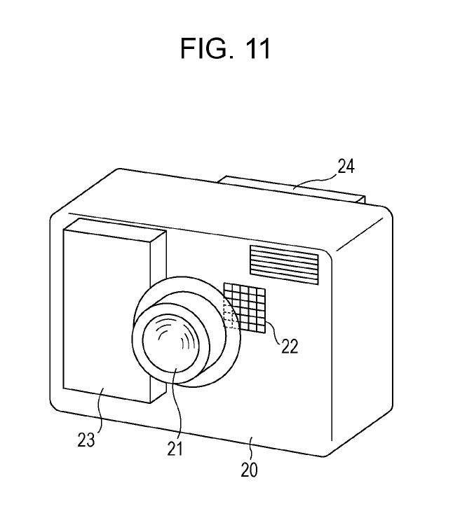

FIG. 11 is a schematic diagram of the relevant part of an image pickup apparatus according to an embodiment of the present invention. Zoom lenses according to some embodiments of the present invention are used in image pickup apparatuses, such as a digital camera, a video camera, and a silver halide film camera, observation apparatuses, such as a telescope and a binocular, and optical apparatuses, such as a copying machine and a projector. In the cross-sectional views of the lenses, the left is the front (object side, scaling-up side), and the right is the rear (image side, scaling-down side). In the numerical examples, reference sign i denotes the order of the lens units from the object side to the image side, and Bi denotes the ith lens unit.

In the cross-sectional views of the examples, reference sign B1 denotes a first lens unit having positive refracting power (optical power=the reciprocal of a focal length), B2 denotes a second lens unit having negative refracting power, B3 is a third lens unit having positive refracting power, B4 is a fourth lens unit having negative refracting power, and B5 denotes a fifth lens unit having positive refracting power. Reference sign SP denotes an F-number determination member (hereinafter also referred to as an aperture stop) serving as an aperture stop for determining (limiting) an open F-number (Fno) light flux and is disposed in the fifth lens unit B5.

Reference sign FC denotes a flare-cut stop, which is disposed at the image side with respect to the fifth lens unit B5. Reference sign GB denotes an optical block corresponding to an optical filter, a face plate, a liquid-crystal low-pass filter, an infrared cut filter, or the like. Reference sign IP denotes an image plane, for which an imaging plane (surface) of a solid-state image pickup device (photoelectric conversion element), such as a CCD sensor or a CMOS sensor, when the zoom lens is used as an imaging optical system of a video camera or a digital still camera. When the zoom lens is used as an imaging optical system of a silver halide film camera, the image plane IP refers to a photosensitive surface corresponding to where a film surface is placed.

In the spherical aberration diagrams, the solid lines represent a d-line, and the two-dot chain lines represent a g-line. In the astigmatism diagrams, the dotted lines represent meridional image planes, and the solid lines represent sagittal image planes. Magnification chromatic aberration is represented by the g-line. In the cross-sectional views, the arrows indicate the moving loci of the individual lens units when zooming from the wide-angle end to telephoto end. In the zoom lenses of the examples, all of the lens units move when zooming from the wide-angle end to the telephoto end. Specifically, all of the lens units move toward the object side.

At that time, when zooming from the wide-angle end to the telephoto end, the distances between the lens units change as follows: the distance between a first lens unit L1 and a second lens unit L2 increases; the distance between the second lens unit L2 and a third lens unit L3 decreases, the distance between the third lens unit L3 and a fourth lens unit L4 increases, and the distance between the fourth lens unit L4 and a fifth lens unit L5 decreases. The flare-cut stop FC does not move during zooming.

In each embodiment, the zoom lens has a five unit configuration including, in order from the object side to the image side, five lens units having positive, negative, positive, negative, and positive refracting power to ensure a sufficient zoom ratio while maintaining the entire lens system compact. Advantageously, high optical performance is achieved by properly setting the refracting power, the moving locus, and other parameters of the lens units during zooming.

Setting the lens unit configuration to be symmetrical in refracting power with respect to the object side and the image side makes it easy to correct the aberrations. Four-unit zoom lenses constituted by lens units having positive, negative, positive, and positive refracting power generally have a lens configuration that can provide a high zoom ratio even though the entire lens system is compact. Decreasing the focal length of the four-unit zoom lens at the wide-angle end to increase the wide angle of view would extremely increase the effective front lens diameter.

In contrast, the five-unit zoom lens according to embodiments of the present invention including the first to fifth lens units having positive, negative, positive, negative, and positive refracting power can easily decrease the height of incidence of off-axis ray that passes through the first lens unit B1 in a zoom region in the vicinity of the wide-angle end that determines the front-lens effective diameter. This makes it easy to decrease the diameter of the entire lens system.

Furthermore, the five-unit zoom lens according to the embodiments described herein of the present invention optimally shares the zooming action by moving the fourth lens unit B4 having negative refracting power together with the second lens unit B2 having negative refracting power serving as the main zoom lens unit at different loci when zooming. The five-unit zoom lens thus achieves a high zoom ratio with a short entire lens length and also reduces the effective front lens diameter and the entire lens length. Therefore, the examples of the present invention make the most of the moving space of the lens units by moving the lens units when zooming, thereby ensuring a sufficient zoom ratio while maintaining the compact entire lens system.

Furthermore, the five-unit zoom lens integrates the zooming mechanism by moving the third lens unit B3 and the fifth lens unit B5 together when zooming to achieve the size reduction of the entire lens barrel including a driving unit. For application to a lens replaceable camera (image pickup apparatus), many components, such as a joining member for the zoom lens and the camera main body and electrical-signal contacts, are present in the vicinity of the image plane of the zoom lens. This makes it difficult to independently move the fifth lens unit B5 in the vicinity of the image plane, and thus, the third lens unit B3 and the fifth lens unit B5 are moved together.

The focusing operation is performed by moving the third lens unit B3 or the fourth lens unit B4. The incident height of off-axis ray is low between the image plane side of the second lens unit B2 and the aperture stop SP. Therefore, the entire lens barrel system including a focus driving mechanism and a power unit is reduced in size by performing focusing a small-diameter lens. To reduce the size of a lens system, it is generally effective to decrease a back focus; however, extremely reducing the back focus while reducing the size of the lens system would excessively reduce the distance of an exit pupil at the wide-angle end.

In particular, in an image pickup apparatus that uses a CCD sensor or a CMOS sensor as an image pickup device, a short distance from the image plane to the exit pupil disadvantageously causes shading. Accordingly, the distance to the exit pupil may be increased to some extent by providing a back focus having an appropriate length. Thus, the examples adopt the following configurations:

The following conditional expression is to be satisfied:

0.5<|f2|/skw<3.0 (1)

where f2 is the focal length of the second lens unit B2, and skw is a back focus of the zoom lens at the wide-angle end. Where the back focus is defined as a distance from the last lens surface to a paraxial image plane of the zoom lens.

Conditional expression (1) is for ensuring a back focus having an appropriate length while achieving a compact entire lens system by determining the ratio of the focal length of the second lens unit B2 having a main zooming function to the back focus. If the back focus is shorter than the upper limit of conditional expression (1), the entire lens length at the wide-angle end decreases, but distance to the exit pupil decreases, which increases the incident angle of the principal ray to the image plane (image pickup device), which causes much shading, resulting in low image quality. Furthermore, the short back focus excessively increases the focal length of the second lens unit B2, which increases the amount of movement when zooming, thus making it difficult to reduce the size of the entire apparatus.

If the back focus is longer than the lower limit of conditional expression (1), the entire lens length at the wide-angle end increases. Furthermore, the long back focus excessively reduces the focal length of the second lens unit B2, which increases a change in the curvature of field, thus making it difficult to correct it.

In the examples, at least one of the following conditional expressions (2) to (8) may be satisfied to provide higher optical performance.

0.3<−L2tw/skw<3.0 (2)

3.0<f1/|f2|<7.0 (3)

0.5<f35w/skw<3.0 (4)

0.5<|f2|/fw<2.0 (5)

0.5<f1/ft<3.5 (6)

0.1<|f2|/√(fw·ft)<1.5 (7)

0.5<L1tw/L2tw<6.0 (8)

where L1tw and L2tw are the amounts of movement of the first lens unit B1 and the second lens unit B2 when zooming from the wide-angle end to the telephoto end, respectively, f1 is the focal length of the first lens unit B1, f35w is the combined focal length of the third lens unit B3 to the fifth lens unit B5 during focusing on an object at infinity at the wide-angle end, fw is the focal length of the entire zoom lens at the wide-angle end, and ft is the focal length of the entire zoom lens at the telephoto end. It should be noted that the amounts of movement of the first lens unit B1 and the second lens unit B2 when zooming from the wide-angle end are amounts of movement with respect to the image plane. Therefore, for example, the amount of movement of the first lens unit can be calculated from a difference between a lens total length at the wide-angle end and a lens total length at the telephoto end.

Let positive be the sign of the movement of the lens units from the object side to the image side, and let negative be the movement from the image side to object side.

Next, the technical meaning of the individual conditional expressions (2) to (8) will be described.

Conditional expression (2) appropriately defines the ratio of the amount of movement of the second lens unit B2 when zooming from the wide-angle end to the telephoto end to the back focus at the wide-angle end. If the amount of movement of the second lens unit B2 when zooming from the wide-angle end to the telephoto end is larger than the upper limit of conditional expression (2), it is difficult to achieve a compact entire lens system. If the back focus at the wide-angle end is longer than the lower limit of conditional expression (2), it is difficult to achieve a compact entire lens system.

Conditional expression (3) appropriately defines the ratio of the focal length of the first lens unit B1 to that of the second lens unit B2. If the refracting power of the first lens unit B1 is smaller than the upper limit of conditional expression (3), the amount of movement of the first lens unit B1 when zooming from the wide-angle end to the telephoto end increases, which makes it difficult to achieve a compact entire lens system. If the negative refracting power of the second lens unit B2 is smaller than the lower limit of the conditional expression (3), the amount of movement of the second lens unit B2 when zooming from the wide-angle end to the telephoto end increases, which makes it difficult to achieve a compact entire lens system.

Conditional expression (4) appropriately defines the ratio of the combined focal length of the third lens unit B3 to the fifth lens unit B5 to the back focus at the wide-angle end. If the back focus is smaller than the upper limit of the conditional expression (4), the entire lens length at the wide-angle end is small, but the distance to the exit pupil tends to decrease, which increases the incident angle of the principal ray to the image pickup device. This causes much shading, resulting in low image quality. If the back focus is longer than the lower limit of conditional expression (4), it is difficult to achieve a compact entire lens system.

Conditional expression (5) appropriately defines the ratio of the focal length of the second lens unit B2 to the focal length of the entire lens system at the wide-angle end. If the refracting power of the second lens unit B2 is smaller than the upper limit of the conditional expression (5), the amount of movement of the second lens unit B2 when zooming from the wide-angle end to the telephoto end excessively increases, which makes it difficult to achieve a compact entire lens system. If the focal length of the second lens unit B2 is smaller than the lower limit of conditional expression (5), it is easy to achieve a compact entire lens system, but a change in field curvature when zooming increases, which makes it difficult to correct the change.

Conditional expression (6) appropriately defines the ratio of the focal length of the first lens unit B1 to the focal length of the entire lens system at the telephoto end. If the refracting power of the first lens unit B1 is smaller than the upper limit of conditional expression (6), the amount of movement of the first lens unit B1 when zooming from the wide-angle end to the telephoto end excessively increases, which makes it difficult to achieve a compact entire lens system. If the focal length of the first lens unit B1 is smaller than the lower limit of conditional expression (6), it is easy to achieve a compact entire lens system, but the axial chromatic aberration at the telephoto end increases, which makes it difficult to correct the axial chromatic aberration.

Conditional expression (7) is for appropriately correcting aberration during zooming by appropriately setting the refracting power of the second lens unit B2. If the refracting power of the second lens unit B2 is smaller than the upper limit of conditional expression (7), the amount of movement of the second lens unit B2 when zooming from the wide-angle end to the telephoto end increases, which makes it difficult to achieve a compact entire lens system. If the refracting power of the second lens unit B2 is larger than the lower limit of conditional expression (7), an image plane variation and a magnification chromatic aberration variation during zooming increase, which makes it difficult to maintain high optical performance in the entire zoom range.

Conditional expression (8) appropriately defines the ratio of the amount of movement of the first lens unit B1 to the amount of movement of the second lens unit B2 when zooming from the wide-angle end to the telephoto end. Exceeding the upper limit of conditional expression (8) excessively decreases the amount of movement of the second lens unit B2 when zooming from the wide-angle end to the telephoto end, which requires increasing the refracting power of the second lens unit B2. Increasing the refracting power of the second lens unit B2 increases an image plane variation and a magnification chromatic aberration variation during zooming, which makes it difficult to maintain high optical performance.

Exceeding the lower limit of conditional expression (8) excessively decreases the amount of movement of the first lens unit B1, which requires increasing the refracting power of the first lens unit B1. Increasing the refracting power of the first lens unit B1 makes it difficult to correct an axial chromatic aberration and a magnification chromatic aberration mainly at the telephoto end, which makes it difficult to maintain high optical performance. In the examples, it is more preferable to set the numerical ranges of Conditional expressions (1) to (8) as follows:

0.8<|f2|/skw<2.0 (1a)

0.4<−L2tw/skw<2.0 (2a)

4.5<f1/|f2|<6.5 (3a)

1.0<f35w/skw<2.5 (4a)

0.6<|f2|/fw<1.5 (5a)

1.0<f1/ft<2.5 (6a)

0.3<|f2|/√(fw·ft)<1.0 (7a)

1.0<L1tw/L2tw<4.5 (8a)

More preferably, the numerical ranges of Conditional expressions (1a) to (8a) are set as follows:

1.00<|f2|/skw<1.35 (1b)

0.45<−L2tw/skw<0.80 (2b)

5.0<f1/|f2|<6.0 (3b)

1.3<f35w/skw<1.6 (4b)

0.8<|f2|/fw<1.0 (5b)

1.3<f1/ft<2.0 (6b)

0.4<|f2|/√(fw·ft)<0.6 (7b)

2.5<L1tw/L2tw<4.0 (8b)

With the examples, a zoom lens having high performance and a sufficient zoom ratio can be provided while the size of the entire image pickup apparatus including a zooming mechanism and a focusing mechanism can be reduced.

In the examples, all of the lens units (first to fifth lens units) move toward the object side when zooming from the wide-angle end to the telephoto end. When all of the lens units move toward the object side when zooming from the wide-angle end to the telephoto end, the entire lens length is reduced at the wide-angle end. Since the zooming position while the image pickup apparatus being carried is desirably at the wide-angle end in view of snapshooting, a configuration in which the lens entire length is the smallest at the wide-angle end is employed. In the examples, a focusing operation is performed by the third lens unit B3 or the fourth lens unit B4.

Since the incident height of off-axial ray passing through the third lens unit B3 or the fourth lens unit B4 is small, so that the lens diameter can be decreased, focusing with the third lens unit B3 or the fourth lens unit B4 makes it easy to achieve a small focusing mechanism.

In the examples, the second lens unit B2 may include three lenses or less and may include at least one aspherical surface. This makes it easy to provide high optical performance while achieving a compact entire lens system. In the examples, the first lens unit B1 may include two lenses or less. This makes it easy to provide high optical performance while achieving a compact entire lens system. In the examples, any lens unit may be moved to a direction having a component perpendicular to the optical axis to correct an image blur when the zoom lens vibrates.

With the examples, a compact zoom lens having an imaging angle of view of about 73 degrees, a zoom ratio of about 2.9, and an aperture ratio of about 3.6 to 5.8 at the wide-angle end. Next, the lens configurations of the individual lens units will be described. Unless otherwise noted, the lens units are arranged in order from the object side to the image side. The first lens unit B1 is a cemented lens in which a negative lens and a positive lens are combined.

The second lens unit B2 has refracting power whose absolute value at the image side is larger than at the object side and is constituted by a negative lens that is concave to the image side, a biconcave negative lens, and a positive lens that is convex to the object side. The third lens unit B3 is constituted by a positive lens that is convex to the object side. The fourth lens unit B4 is constituted by a single negative lens that is concave to the object side. The fifth lens unit B5 is constituted by a cemented lens in which a positive lens and a negative lens are combined, a positive lens, a negative lens, and a lens that is convex to the object side, and a positive lens that is concave to the object side.

The thus-configured lens units allow high optical performance to be provided over the entire zoom range.

Next, a digital still camera according to an embodiment of the present invention in which the zoom lens in any of the examples is used as an imaging optical system will be described with reference to FIG. 11. In FIG. 11, reference sign 20 denotes a camera main body, 21 denotes an imaging optical system constituted by any of the zoom lenses described in Examples 1 to 5, 22 denotes a solid-state image pickup device (photoelectric conversion element), such as a CCD sensor and a CMOS sensor, that is built in the camera main body and that receives an image of the subject formed by the imaging optical system 21, and 23 denotes a memory that stores information corresponding to the subject image that is photoelectrically converted by the solid-state image pickup device 22.

Reference sign 24 denotes a finder constituted by a liquid-crystal display panel or the like, for observing the subject image formed on the solid-state image pickup device 22. By applying the zoom lens according to some embodiment of the present invention to an image pickup apparatus, such as a digital still camera, a compact image pickup apparatus having high optical performance can be achieved.

The zoom lens according to some embodiment of the present invention can also be applied to a mirror-less single-lens reflex camera without a quick-return mirror.

Next, numerical examples corresponding to the examples of the present invention will be described. In the numerical examples, i denotes the order of the surfaces from the object side. In the numerical examples, reference sign ri denotes the radius of curvature of the ith lens surface from the object side, di denotes the length and air space of the ith lens from the object side, and ndi and vdi are the refractive index and the Abbe number of the glass material of the ith lens from the object side, respectively. The last four surfaces are of glass blocks. In the numerical examples, the glass blocks are expressed as a sixth lens unit (focal length ∞) for the purpose of convenience.

Assume that the optical axis is taken as the X-axis, the direction perpendicular to the optical axis is taken as the H-axis, and the traveling direction of light is positive. The aspherical surface shape is expressed as Equation 1:

$$X = \frac{( 1 / R ) {H}^{2}}{1 + \sqrt{1 - ( 1 + K ) {( H / R )}^{2}}} + A 4 \times {H}^{4} + A 6 \times {H}^{6} + A 8 \times {H}^{8} + A 10 \times {H}^{10} + A 12 \times {H}^{12} \qquad ( 1 )$$

where R is the paraxial radius of curvature, K is a conic constant, and A4, A6, A8, A10, and A12 are aspherical surface coefficients. In the numerical examples, [e+X] means [×10+x], and [e−X] means [×10−x]. Reference sign BF denotes a back focus, which is the distance from the last lens surface to a paraxial image plane (back focus), expressed as a length in air. The entire lens length is a value obtained by adding the back focus BF to the distance from the frontmost lens surface to the last lens surface. The aspherical surface is expressed as a surface number with * (asterisk). Table 1 shows the relationship between the numerical values in the conditional expressions and the numerical examples.

### Numerical Example 1

Unit mm
Surface data

| Surface number | ri | di | ndi | νdi |
|---|---|---|---|---|
| 1 | 46.669 | 1.70 | 1.84666 | 23.9 |
| 2 | 35.524 | 4.60 | 1.69680 | 55.5 |
| 3 | 204.820 | (Variable) | | |
| 4 | 34.378 | 1.20 | 1.83481 | 42.7 |
| 5 | 10.658 | 6.37 | | |
| 6* | −54.819 | 1.00 | 1.85135 | 40.1 |
| 7 | 40.459 | 0.15 | | |
| 8 | 21.274 | 2.60 | 1.92286 | 18.9 |
| 9 | 74.846 | (Variable) | | |
| 10 | 16.794 | 1.40 | 1.77250 | 49.6 |
| 11 | 36.819 | (Variable) | | |
| 12 | −16.363 | 0.55 | 1.88300 | 40.8 |
| 13 | −55.623 | (Variable) | | |
| 14 | 14.081 | 3.80 | 1.69680 | 55.5 |
| 15 | −14.081 | 0.80 | 1.84666 | 23.9 |
| 16 | −24.638 | 0.80 | | |
| 17(Aperture) | ∞ | 2.00 | | |
| 18* | 23.987 | 2.00 | 1.58313 | 59.4 |
| 19* | 82.591 | 2.80 | | |
| 20 | −42.910 | 0.60 | 1.90366 | 31.3 |
| 21 | 26.991 | 6.00 | | |
| 22 | 25.069 | 2.00 | 1.52996 | 55.8 |
| 23* | 25.588 | 1.99 | | |
| 24 | −201.896 | 2.00 | 1.84666 | 23.9 |
| 25 | −43.203 | (Variable) | | |
| 26(Flare-cut stop) | ∞ | 11.00 | | |
| 27 | ∞ | 1.21 | 1.51633 | 64.1 |
| 28 | ∞ | 1.10 | | |
| 29 | ∞ | 0.50 | 1.51633 | 64.1 |
| 30 | ∞ | 0.88 | | |
| Image plane | ∞ | | | |

Aspherical surface data
sixth surface

| | | |
|---|---|---|
| K = 2.03284e+001 | A4 = 1.34534e−005 | A6 = 9.74836e−008 |
| A8 = −5.46269e−010 | A10 = 7.48620e−012 | |

18th surface

| | | |
|---|---|---|
| K = −4.02860e+000 | A4 = −1.06804e−004 | A6 = −4.99512e−006 |
| A8 = −1.13675e−008 | A10 = −3.18466e−009 | A12 = 6.43346e−011 |

19th surface

| | | |
|---|---|---|
| K = 0.00000e+000 | A4 = 1.40820e−004 | A6 = −3.17915e−006 |
| A8 = −8.57069e−008 | A10 = 1.14883e−009 | A12 = −1.17453e−012 |

23rd surface

| | | |
|---|---|---|
| K = −9.67257e−001 | A4 = −2.37994e−005 | A6 = 1.12104e−007 |
| A8 = 5.00265e−011 | | |

Data
Zoom ratio 2.87

| | Wide angle | Intermediate | Telephoto |
|---|---|---|---|
| | end | point | end |
| Focal length | 18.58 | 26.93 | 53.36 |
| F-number | 3.60 | 4.22 | 5.69 |
| Angle of view | 36.33 | 26.90 | 14.36 |
| Image height | 13.66 | 13.66 | 13.66 |
| Entire lens length | 77.64 | 84.84 | 104.21 |
| BF | 14.11 | 19.71 | 33.42 |
| d3 | 0.60 | 7.34 | 20.20 |
| d9 | 12.88 | 7.75 | 0.54 |
| d11 | 3.21 | 3.95 | 4.67 |
| d13 | 2.48 | 1.74 | 1.02 |
| d25 | 0.00 | 5.60 | 19.31 |

Zoom lens unit data

| Unit | First surface | Focal length |
|---|---|---|
| 1 | 1 | 92.79 |
| 2 | 4 | −16.69 |
| 3 | 10 | 38.79 |
| 4 | 12 | −26.43 |
| 5 | 14 | 16.50 |
| 6 | 26 | ∞ |

### Numerical Example 2

Unit mm
Surface data

| Surface number | ri | di | ndi | νdi |
|---|---|---|---|---|
| 1 | 48.069 | 1.70 | 1.84666 | 23.9 |
| 2 | 35.374 | 4.60 | 1.69680 | 55.5 |
| 3 | 249.854 | (Variable) | | |
| 4 | 41.969 | 1.20 | 1.88300 | 40.8 |
| 5 | 11.389 | 5.83 | | |
| 6* | −55.566 | 1.00 | 1.85135 | 40.1 |
| 7 | 41.861 | 0.15 | | |
| 8 | 22.454 | 2.60 | 1.92286 | 18.9 |
| 9 | 102.857 | (Variable) | | |
| 10 | 18.161 | 1.40 | 1.77250 | 49.6 |
| 11 | 45.733 | (Variable) | | |
| 12 | −16.257 | 0.55 | 1.88300 | 40.8 |
| 13 | −50.112 | (Variable) | | |
| 14 | 14.456 | 3.80 | 1.69680 | 55.5 |
| 15 | −14.456 | 0.80 | 1.84666 | 23.9 |
| 16 | −24.556 | 0.80 | | |
| 17(Aperture) | ∞ | 2.00 | | |
| 18* | 26.697 | 2.00 | 1.58313 | 59.4 |
| 19* | 60.656 | 2.80 | | |
| 20 | −78.261 | 0.60 | 1.90366 | 31.3 |
| 21 | 23.143 | 5.91 | | |
| 22 | 24.313 | 2.00 | 1.52996 | 55.8 |
| 23* | 27.163 | 1.93 | | |
| 24 | −200.582 | 2.00 | 1.84666 | 23.9 |
| 25 | −51.615 | (Variable) | | |
| 26(Flare-cut stop) | ∞ | 11.20 | | |
| 27 | ∞ | 2.10 | 1.51633 | 64.1 |
| 28 | ∞ | 1.10 | | |
| 29 | ∞ | 0.70 | 1.51633 | 64.1 |
| 30 | ∞ | 0.45 | | |
| Image plane | ∞ | | | |

Aspherical surface data
sixth surface

| | | |
|---|---|---|
| K = 2.01454e+001 | A4 = 1.61311e−005 | A6 = 4.98362e−008 |
| A8 = −2.27489e−010 | A10 = 6.45267e−012 | |

18th surface

| | | |
|---|---|---|
| K = −4.65498e+000 | A4 = −1.42232e−004 | A6 = −5.00314e−006 |
| A8 = 2.05731e−009 | A10 = −2.40998e−009 | A12 = 5.18785e−011 |

19th surface

| | | |
|---|---|---|
| K = 0.00000e+000 | A4 = 9.04803e−005 | A6 = −3.65425e−006 |
| A8 = −6.01783e−008 | A10 = 1.74702e−009 | A12 = −1.54491e−011 |

23rd surface

| | | |
|---|---|---|
| K = −1.96719e−001 | A4 = −2.03667e−005 | A6 = 5.59434e−008 |
| A8 = 3.37178e−010 | | |

Data
Zoom ratio 2.87

| | Wide angle | Intermediate | Telephoto |
|---|---|---|---|
| | end | point | end |
| Focal length | 18.58 | 26.93 | 53.36 |
| F-number | 3.60 | 4.27 | 5.88 |
| Angle of view | 36.33 | 26.90 | 14.36 |
| Image height | 13.66 | 13.66 | 13.66 |
| Entire lens length | 78.45 | 86.08 | 103.32 |
| BF | 14.60 | 20.32 | 35.46 |
| d3 | 0.60 | 7.19 | 18.02 |
| d9 | 12.87 | 8.19 | 0.58 |
| d11 | 3.49 | 4.59 | 4.10 |
| d13 | 3.22 | 2.13 | 1.50 |
| d25 | 0.00 | 5.72 | 20.86 |

Zoom lens unit data

| Unit | First surface | Focal length |
|---|---|---|
| 1 | 1 | 92.56 |
| 2 | 4 | −16.76 |
| 3 | 10 | 38.15 |
| 4 | 12 | −27.46 |
| 5 | 14 | 16.97 |
| 6 | 26 | ∞ |

### Numerical Example 3

Unit mm
Surface data

| Surface number | ri | di | ndi | νdi |
|---|---|---|---|---|
| 1 | 48.165 | 1.70 | 1.84666 | 23.9 |
| 2 | 35.033 | 4.60 | 1.69680 | 55.5 |
| 3 | 194.567 | (Variable) | | |
| 4 | 38.933 | 1.20 | 1.83481 | 42.7 |
| 5 | 10.827 | 5.51 | | |
| 6* | −62.765 | 1.00 | 1.85135 | 40.1 |
| 7 | 40.461 | 0.15 | | |
| 8 | 21.675 | 2.60 | 1.92286 | 18.9 |
| 9 | 90.996 | (Variable) | | |
| 10 | 17.435 | 1.40 | 1.77250 | 49.6 |
| 11 | 40.131 | (Variable) | | |
| 12 | −15.403 | 0.55 | 1.88300 | 40.8 |
| 13 | −50.515 | (Variable) | | |
| 14 | 14.026 | 3.80 | 1.69680 | 55.5 |
| 15 | −14.026 | 0.80 | 1.84666 | 23.9 |
| 16 | −24.508 | 0.80 | | |
| 17(Aperture) | ∞ | 2.00 | | |
| 18* | 23.834 | 2.00 | 1.58313 | 59.4 |
| 19* | 69.653 | 2.80 | | |
| 20 | −49.861 | 0.60 | 1.90366 | 31.3 |
| 21 | 27.943 | 6.00 | | |
| 22 | 25.561 | 2.00 | 1.52996 | 55.8 |
| 23* | 25.769 | 1.99 | | |
| 24 | −202.724 | 2.00 | 1.84666 | 23.9 |
| 25 | −47.165 | (Variable) | | |
| 26(Flare-cut stop) | ∞ | 11.00 | | |
| 27 | ∞ | 1.21 | 1.51633 | 64.1 |
| 28 | ∞ | 1.10 | | |
| 29 | ∞ | 0.50 | 1.51633 | 64.1 |
| 30 | ∞ | 0.51 | | |
| Image plane | ∞ | | | |

Aspherical surface data
sixth surface

| | | |
|---|---|---|
| K = 2.11187e+001 | A4 = 1.66904e−005 | A6 = 4.76149e−008 |
| A8 = −2.68862e−010 | A10 = 6.60931e−012 | |

18th surface

| | | |
|---|---|---|
| K = −3.72637e+000 | A4 = −1.04797e−004 | A6 = −5.22298e−006 |
| A8 = −9.87641e−009 | A10 = −3.72730e−009 | A12 = 8.33032e−011 |

19th surface

| | | |
|---|---|---|
| K = 0.00000e+000 | A4 = 1.44913e−004 | A6 = −3.92783e−006 |
| A8 = −8.35869e−008 | A10 = 1.06468e−009 | A12 = 6.86678e−012 |

23rd surface

| | | |
|---|---|---|
| K = −7.38983e−001 | A4 = −2.14446e−005 | A6 = 7.82317e−008 |
| A8 = 4.06522e−010 | | |

Data
Zoom ratio 2.87

| | Wide | Intermediate | Telephoto |
|---|---|---|---|
| | angle end | point | end |
| Focal length | 18.58 | 26.94 | 53.35 |
| F-number | 3.60 | 4.21 | 5.88 |
| Angle of view | 36.32 | 26.89 | 14.36 |
| Image height | 13.66 | 13.66 | 13.66 |
| Entire lens length | 75.61 | 83.35 | 105.81 |
| BF | 13.74 | 19.34 | 33.88 |
| d3 | 0.60 | 7.65 | 21.03 |
| d9 | 10.90 | 5.99 | 0.52 |
| d11 | 3.19 | 4.13 | 5.88 |
| d13 | 3.68 | 2.74 | 0.99 |
| d25 | 0.00 | 5.60 | 20.15 |

Zoom lens unit data

| Unit | First surface | Focal length |
|---|---|---|
| 1 | 1 | 100.24 |
| 2 | 4 | −17.53 |
| 3 | 10 | 38.86 |
| 4 | 12 | −25.28 |
| 5 | 14 | 16.10 |
| 6 | 26 | ∞ |

### Numerical Example 4

Unit mm
Surface data

| Surface number | ri | di | ndi | νdi |
|---|---|---|---|---|
| 1 | 44.305 | 1.70 | 1.84666 | 23.9 |
| 2 | 34.771 | 4.60 | 1.69680 | 55.5 |
| 3 | 226.072 | (Variable) | | |
| 4 | 38.714 | 1.20 | 1.83481 | 42.7 |
| 5 | 10.800 | 7.19 | | |
| 6* | −51.794 | 1.00 | 1.85135 | 40.1 |
| 7 | 40.772 | 0.15 | | |
| 8 | 21.453 | 2.60 | 1.92286 | 18.9 |
| 9 | 68.226 | (Variable) | | |
| 10 | 16.726 | 1.40 | 1.77250 | 49.6 |
| 11 | 38.471 | (Variable) | | |
| 12 | −16.061 | 0.55 | 1.88300 | 40.8 |
| 13 | −50.683 | (Variable) | | |
| 14 | 14.289 | 3.80 | 1.69680 | 55.5 |
| 15 | −14.289 | 0.80 | 1.84666 | 23.9 |
| 16 | −24.295 | 0.80 | | |
| 17(Aperture) | ∞ | 2.00 | | |
| 18* | 23.746 | 2.00 | 1.58313 | 59.4 |
| 19* | 65.777 | 2.80 | | |
| 20 | −45.568 | 0.60 | 1.90366 | 31.3 |
| 21 | 28.922 | 6.00 | | |
| 22 | 24.803 | 2.00 | 1.52996 | 55.8 |
| 23* | 25.711 | 2.04 | | |
| 24 | −202.249 | 2.00 | 1.84666 | 23.9 |
| 25 | −50.213 | (Variable) | | |
| 26(Flare-cut stop) | ∞ | 11.00 | | |
| 27 | ∞ | 1.21 | 1.51633 | 64.1 |
| 28 | ∞ | 1.10 | | |
| 29 | ∞ | 0.50 | 1.51633 | 64.1 |
| 30 | ∞ | 0.94 | | |
| Image plane | ∞ | | | |

Aspherical surface data
sixth surface

| | | |
|---|---|---|
| K = 1.91051e+001 | A4 = 1.43248e−005 | A6 = 3.94993e−008 |
| A8 = 2.78213e−010 | A10 = 3.70816e−012 | |

18th surface

| | | |
|---|---|---|
| K = −3.94949e+000 | A4 = −1.04422e−004 | A6 = −5.13838e−006 |
| A8 = 8.32479e−009 | A10 = −3.92311e−009 | A12 = 7.33778e−011 |

19th surface

| | | |
|---|---|---|
| K = 0.00000e+000 | A4 = 1.52149e−004 | A6 = −3.49298e−006 |
| A8 = −6.80727e−008 | A10 = 1.28963e−009 | A12 = −1.48199e−011 |

23rd surface

| | | |
|---|---|---|
| K = −1.11080e+000 | A4 = −2.18724e−005 | A6 = 1.45827e−007 |
| A8 = −1.06814e−010 | | |

Data
Zoom ratio 2.88

| | Wide angle | Intermediate | Telephoto |
|---|---|---|---|
| | end | point | end |
| Focal length | 18.50 | 26.82 | 53.35 |
| F-number | 3.60 | 4.21 | 5.84 |
| Angle of view | 36.44 | 26.99 | 14.36 |
| Image height | 13.66 | 13.66 | 13.66 |
| Entire lens length | 77.76 | 84.53 | 102.40 |
| BF | 14.17 | 19.77 | 34.85 |
| d3 | 0.60 | 6.76 | 16.80 |
| d9 | 12.78 | 7.79 | 0.53 |
| d11 | 3.15 | 3.64 | 4.03 |
| d13 | 1.83 | 1.34 | 0.95 |
| d25 | 0.00 | 5.60 | 20.68 |

Zoom lens unit data

| Unit | First surface | Focal length |
|---|---|---|
| 1 | 1 | 83.53 |
| 2 | 4 | −15.28 |
| 3 | 10 | 37.26 |
| 4 | 12 | −26.83 |
| 5 | 14 | 16.25 |
| 6 | 26 | ∞ |

### Numerical Example 5

Unit mm
Surface data

| Surface number | ri | di | ndi | νdi |
|---|---|---|---|---|
| 1 | 46.309 | 1.70 | 1.84666 | 23.9 |
| 2 | 34.780 | 4.60 | 1.69680 | 55.5 |
| 3 | 204.056 | (Variable) | | |
| 4 | 35.515 | 1.20 | 1.83481 | 42.7 |
| 5 | 10.550 | 6.30 | | |
| 6* | −53.241 | 1.00 | 1.85135 | 40.1 |
| 7 | 39.723 | 0.15 | | |
| 8 | 21.441 | 2.60 | 1.92286 | 18.9 |
| 9 | 78.265 | (Variable) | | |
| 10 | 17.111 | 1.40 | 1.77250 | 49.6 |
| 11 | 41.526 | (Variable) | | |
| 12 | −16.167 | 0.55 | 1.88300 | 40.8 |
| 13 | −47.856 | (Variable) | | |
| 14 | 14.163 | 3.80 | 1.69680 | 55.5 |
| 15 | −14.163 | 0.80 | 1.84666 | 23.9 |
| 16 | −25.053 | 0.80 | | |
| 17(Aperture) | ∞ | 2.00 | | |
| 18* | 23.159 | 2.00 | 1.58313 | 59.4 |
| 19* | 63.771 | 2.80 | | |
| 20 | −41.311 | 0.60 | 1.90366 | 31.3 |
| 21 | 26.610 | 6.00 | | |
| 22 | 25.007 | 2.00 | 1.52996 | 55.8 |
| 23* | 25.467 | 2.03 | | |
| 24 | −198.895 | 2.00 | 1.84666 | 23.9 |
| 25 | −42.374 | (Variable) | | |
| 26(Flare-cut stop) | ∞ | 12.00 | | |
| 27 | ∞ | 0.60 | 1.54400 | 60.0 |
| 28 | ∞ | 0.61 | 1.55900 | 58.6 |
| 29 | ∞ | 1.10 | | |
| 30 | ∞ | 0.50 | 1.54400 | 60.0 |
| 31 | ∞ | 0.50 | | |
| 32 | ∞ | 0.03 | | |
| Image plane | ∞ | | | |

Aspherical surface data
sixth surface

| | | |
|---|---|---|
| K = 1.91462e+001 | A4 = 1.59369e−005 | A6 = 9.15691e−008 |
| A8 = −6.81210e−010 | A10 = 1.02632e−011 | |

18th surface

| | | |
|---|---|---|
| K = −3.88573e+000 | A4 = −1.03506e−004 | A6 = −5.13791e−006 |
| A8 = −1.07158e−008 | A10 = −3.10634e−009 | A12 = 6.52415e−011 |

19th surface

| | | |
|---|---|---|
| K = 0.00000e+000 | A4 = 1.37818e−004 | A6 = −3.69039e−006 |
| A8 = −8.05055e−008 | A10 = 1.61815e−009 | A12 = −1.62229e−011 |

23rd surface

| | | |
|---|---|---|
| K = −9.54387e−001 | A4 = −2.37544e−005 | A6 = 9.81429e−008 |
| A8 = 2.16017e−010 | | |

Data
Zoom ratio 2.87

| | | | |
|---|---|---|---|
| Focal length | 18.58 | 27.00 | 53.35 |
| F-number | 3.60 | 4.27 | 5.83 |
| Angle of view | 36.33 | 26.84 | 14.36 |
| Image height | 13.66 | 13.66 | 13.66 |
| Entire lens length | 77.71 | 85.24 | 105.65 |
| BF | 13.74 | 19.70 | 34.18 |
| d3 | 0.60 | 7.04 | 19.68 |
| d9 | 12.12 | 7.25 | 0.54 |
| d11 | 4.25 | 5.12 | 5.92 |
| d13 | 2.67 | 1.80 | 1.00 |
| d25 | −1.00 | 4.96 | 19.44 |

Zoom lens unit data

| Unit | First surface | Focal length |
|---|---|---|
| 1 | 1 | 92.43 |
| 2 | 4 | −16.02 |
| 3 | 10 | 36.76 |
| 4 | 12 | −27.88 |
| 5 | 14 | 17.00 |
| 6 | 26 | ∞ |

TABLE 1
Correlation between numerical values in
examples and conditional expressions

| | | EXAM- | EXAM- | EXAM- | EXAM- | EXAM- |
|---|---|---|---|---|---|---|
| | | PLE 1 | PLE 2 | PLE 3 | PLE 4 | PLE 5 |
| | fw | 18.58 | 18.58 | 18.58 | 18.50 | 18.58 |
| | ft | 53.36 | 53.36 | 53.35 | 53.35 | 53.35 |
| | skw | 14.11 | 14.60 | 13.74 | 14.17 | 13.74 |
| | f1 | 92.79 | 92.56 | 100.24 | 83.53 | 92.43 |
| | f2 | −16.69 | −16.76 | −17.53 | −15.28 | −16.02 |
| | f35w | 21.15 | 21.27 | 20.84 | 20.45 | 21.11 |
| | L1wt | 26.56 | 24.87 | 30.20 | 24.63 | 27.94 |
| | L2wt | 6.97 | 7.45 | 9.77 | 8.43 | 8.86 |
| Exp. 1 | \|f2\|/skw | 1.183 | 1.148 | 1.277 | 1.079 | 1.166 |
| Exp. 2 | L2tw/skw | 0.494 | 0.510 | 0.711 | 0.595 | 0.645 |
| Exp. 3 | f1/\|f2\| | 5.561 | 5.523 | 5.717 | 5.465 | 5.770 |
| Exp. 4 | f35w/skw | 1.499 | 1.457 | 1.518 | 1.443 | 1.537 |
| Exp. 5 | \|f2\|/fw | 0.898 | 0.902 | 0.944 | 0.826 | 0.862 |
| Exp. 6 | f1/fw | 1.739 | 1.735 | 1.879 | 1.565 | 1.732 |
| Exp. 7 | \|f2\|/√(fw · ft) | 0.530 | 0.532 | 0.557 | 0.486 | 0.509 |
| Exp. 8 | L1tw/L2tw | 3.813 | 3.338 | 3.091 | 2.923 | 3.154 |

While the present invention has been described with reference to exemplary embodiments, it is to be understood that the invention is not limited to the disclosed exemplary embodiments. The scope of the following claims is to be accorded the broadest interpretation so as to encompass all such modifications and equivalent structures and functions.

This application claims the benefit of Japanese Patent Application No. 2011-250499, filed Nov. 16, 2011, which is hereby incorporated by reference herein in its entirety.

What is claimed is:

1. A zoom lens comprising, in order from an object side to an image side:
a first lens unit having positive refracting power;
a second lens unit having negative refracting power;
a third lens unit having positive refracting power;
a fourth lens unit having negative refracting power; and
a fifth lens unit having positive refracting power,
wherein the lens units move when zooming from the wide-angle end to the telephoto end;
the third lens unit and the fifth lens unit move together when zooming;
the fifth lens unit includes an aperture stop;
the third lens unit or the fourth lens unit moves during focusing; and
the following conditional expression is satisfied:
0.5<|f2|/skw<3.0
where f2 is the focal length of the second lens unit, and skw is a back focus at the wide-angle end.

2. The zoom lens according to claim 1, wherein all of the lens units move toward the object side when zooming from the wide-angle end to the telephoto end.

3. The zoom lens according to claim 1, wherein the following conditional expression is satisfied:
0.3<−L2tw/skw<3.0
where L2tw is the amount of movement of the second lens unit when zooming from the wide-angle end to the telephoto end.

4. The zoom lens according to claim 1, wherein the following conditional expression is satisfied:
3.0<f1/|f2|<7.0
where f1 is the focal length of the first lens unit.

5. The zoom lens according to claim 1, wherein the following conditional expression is satisfied:
0.5<f35w/skw<3.0
where f35w is the combined focal length of the third lens unit to the fifth lens unit when focusing on an object at infinity at the wide-angle end.

6. The zoom lens according to claim 1, wherein the following conditional expression is satisfied:
0.5<|f2|/fw<2.0
where fw is the focal length of the entire zoom lens at the wide-angle end.

7. The zoom lens according to claim 1, wherein the following conditional expression is satisfied:
0.5<f1/ft<3.5
where f1 is the focal length of the first lens unit, and ft is the focal length of the entire zoom lens at the telephoto end.

8. The zoom lens according to claim 1, wherein the following conditional expression is satisfied:
0.1<|f2|/√(fw·ft)<1.5
where fw is the focal length of the entire zoom lens at the wide-angle end, and ft is the focal length of the entire zoom lens at the telephoto end.

9. The zoom lens according to claim 1, wherein the following conditional expression is satisfied:
0.5<L1tw/L2tw<6.0
where L1tw is the amount of movement of the first lens unit, and L2tw is the amount of movement of the second lens unit when zooming from the wide-angle end to the telephoto end.

10. The zoom lens according to claim 9, wherein, when zooming from the wide-angle end to the telephoto end, L1tw is an amount of movement of the first lens unit with respect to the image plane, and L2tw is an amount of movement of the second lens unit with respect to the image plane.

11. An image pickup apparatus comprising:
the zoom lens according to claim 1; and
an image pickup device that receives an image formed by the zoom lens.
